(19) United States
(12) Patent Application Publication
(10) Pub. No.: US 2025/0157152 A1
(43) Pub. Date: May 15, 2025

(54) AUTOMATIC GENERATION OF AVATAR BODY MODELS

(71) Applicant: Roblox Corporation, San Mateo, CA (US)

(72) Inventors: Andrew KUNZ, San Mateo, CA (US); Weiqi Shi, San Mateo, CA (US); Adam Tucker Burr, Suffern, NY (US); Si Chen, San Mateo, CA (US); Byungmoon Kim, San Jose, CA (US); Kevin Lu, San Mateo, CA (US); Krish Matta, San Mateo, CA (US); Noor Nasri, San Mateo, CA (US); Tallon Hodge, San Mateo, CA (US)

(73) Assignee: Roblox Corporation, San Mateo, CA (US)

(21) Appl. No.: 18/944,788

(22) Filed: Nov. 12, 2024

Related U.S. Application Data
(60) Provisional application No. 63/548,291, filed on Nov. 13, 2023.

(51) Int. Cl. G06T 17/20; G06T 7/11; G06T 7/73; G06T 13/40

(52) U.S. Cl. CPC G06T 17/205; G06T 7/11; G06T 7/75; G06T 13/40; G06T 2200/04; G06T 2210/56

(57) ABSTRACT

Implementations relate to methods, systems, and computer-readable media to automatically generate an avatar body model based on a three-dimensional (3D) mesh. In some implementations, the method may include obtaining a 3D mesh of a virtual character, generating a skeleton for the virtual character based on the 3D mesh, wherein individual joints of a plurality of joints are pre-defined joints based on a body type of the virtual character; associating each of the plurality of joints of the skeleton to at least one respective vertex of the plurality of vertices of the 3D mesh to obtain a skinned 3D mesh, segmenting the skinned 3D mesh, based on skinning weights associated with the plurality of vertices into a plurality of body part meshes that correspond to respective body parts of the virtual character, and determining a cage mesh for each body part mesh.

### CROSS-REFERENCE TO RELATED APPLICATIONS

This application claims priority to U.S. Provisional Application No. 63/548,291, entitled “AUTOMATIC SETUP FOR AVATAR BODIES,” filed on Nov. 13, 2023, the content of which is incorporated herein in its entirety.

### TECHNICAL FIELD

Embodiments relate generally to computer-based virtual experiences and computer graphics, and more particularly, to methods, systems, and computer readable media to automatically generate avatar body models based on three-dimensional (3D) meshes of virtual avatars.

### BACKGROUND

Some online virtual experience platforms allow users to connect with each other, interact with each other (e.g., within a virtual experience), create virtual experiences, and share information with each other via the Internet. Users of online virtual experience platforms may participate in multiplayer environments (e.g., in virtual three-dimensional environments), design custom environments, design characters, three-dimensional (3D) objects, and avatars, decorate avatars, and exchange virtual items/objects with other users.

One of the challenges in computer graphics is the rigging and animation of avatars rendered in virtual environments. Content creators (developers) may start with a 3D mesh of an avatar created or designed according to a particular intent, which has to subsequently be suitably rigged, segmented into body part meshes, and enabled with support for accessory attachment(s). However, the generation of an avatar body model based on the 3D mesh of the avatar that is animation-ready and accessory-ready still poses technical challenges.

The background description provided herein is for the purpose of presenting the context of the disclosure. Work of the presently named inventors, to the extent it is described in this background section, as well as aspects of the description that may not otherwise qualify as prior art at the time of filing, are neither expressly nor impliedly admitted as prior art against the prior disclosure.

### SUMMARY

A system of one or more computers can be configured to perform particular operations or actions by virtue of having software, firmware, hardware, or a combination of them installed on the system that in operation causes the system to perform the actions. One or more computer programs can be configured to perform particular operations or actions by virtue of including instructions that, when executed by data processing apparatus, cause the apparatus to perform a computer-implemented method that includes obtaining a three-dimensional (3D) mesh of a virtual character, wherein the 3D mesh includes a plurality of vertices with respective positions in 3D space with one or more connections between the vertices, generating, based on the 3D mesh, an avatar body model for the virtual character, wherein the avatar body model includes a skinned 3D mesh, a plurality of body part meshes, and cage meshes corresponding to respective body part meshes of the plurality of body part meshes, wherein the generating includes generating a skeleton for the virtual character based on the 3D mesh, wherein the skeleton includes a plurality of joints connected by respective bones, wherein individual joints of the plurality of joints are pre-defined joints based on a body type of the virtual character, associating each of the plurality of joints of the skeleton to at least one respective vertex of the plurality of vertices of the 3D mesh to obtain the skinned 3D mesh, wherein a respective skinning weight is assigned to each vertex of the plurality of vertices, segmenting the skinned 3D mesh, based on the skinning weights associated with the plurality of vertices, into the plurality of body part meshes that correspond to respective body parts of the virtual character, and determining the cage mesh for each body part mesh, and animating the avatar body model to depict motion of the virtual character in a virtual environment.

In some implementations, the computer-implemented method may further include receiving the 3D mesh of the virtual character, and prior to generating the avatar body model, simplifying the 3D mesh to reduce a vertex count of the 3D mesh, wherein the simplifying comprises one or more of filtering, clean-up, or mirroring.

In some implementations, generating the skeleton may include applying a trained machine learning model to the 3D mesh to obtain predicted joint locations of the plurality of joints of the skeleton, wherein vertex positions, topological edges, and geodesic edges of the 3D mesh are provided as input to the trained machine learning model, and building a skeleton hierarchy for the virtual character based on the predicted joint locations.

In some implementations, prior to building the skeleton hierarchy, the computer-implemented method may further include performing at least one operation from the group comprising: removing one or more predicted joint locations that lie external to a bounding box of the 3D mesh, removing one or more predicted joint locations that are isolated, mirroring the predicted joint locations across a plane of symmetry, and any combination thereof.

In some implementations, the computer-implemented method may further include clustering the predicted joint locations to generate the skeleton. In some implementations, building the skeleton hierarchy may include determining whether the predicted joint locations of the plurality of joints are valid, if it is determined that the predicted joint locations are valid, connecting the plurality of joints to bones to determine the skeleton hierarchy, and if it is determined that the predicted joint locations are invalid, determining the skeleton hierarchy based on one of a procedurally generated geometric skeleton and a default skeleton.

In some implementations, the skinning weights may be determined by mapping the 3D mesh to a decimated 3D mesh, wherein two or more vertices of the 3D mesh correspond to a single vertex of the decimated 3D mesh, applying a trained second machine learning model to the decimated 3D mesh to determine intermediate skinning weights for the decimated 3D mesh, wherein a respective volumetric geodesic distance between individual pairs of vertices and bones are provided as input to the trained second machine learning model, and calculating the skinning weights for each vertex of the 3D mesh based on the intermediate skinning weights and the mapping.

In some implementations, segmenting the skinned 3D mesh into the plurality of body part meshes may include determining vertices of the skinned 3D mesh associated with each body part based on the skinning weights.

In some implementations, determining the cage mesh may include, for each body part: applying a trained third machine learning model to the body part mesh of the body part to determine a point cloud that includes a plurality of cage vertices and a canonical connectivity between the plurality of cage vertices, forming a plurality of predicted cage mesh parts based on the plurality of vertices and the canonical connectivity for each vertex, and determining the cage mesh by deforming vertices in the predicted cage mesh parts that lie inside a surface of the body mesh.

One general aspect includes a non-transitory computer-readable medium with instructions stored thereon that when executed, performs operations that include obtaining a three-dimensional (3D) mesh of a virtual character, wherein the 3D mesh includes a plurality of vertices with respective positions in 3D space with one or more connections between the vertices, generating, based on the 3D mesh, an avatar body model for the virtual character, wherein the avatar body model includes a skinned 3D mesh, a plurality of body part meshes, and cage meshes corresponding to respective body part meshes of the plurality of body part meshes, wherein the generating includes generating a skeleton for the virtual character based on the 3D mesh, wherein the skeleton includes a plurality of joints connected by respective bones, wherein individual joints of the plurality of joints are pre-defined joints based on a body type of the virtual character, associating each of the plurality of joints of the skeleton to at least one respective vertex of the plurality of vertices of the 3D mesh to obtain the skinned 3D mesh, wherein a respective skinning weight is assigned to each vertex of the plurality of vertices, segmenting the skinned 3D mesh, based on the skinning weights associated with the plurality of vertices, into the plurality of body part meshes that correspond to respective body parts of the virtual character, and determining the cage mesh for each body part mesh, and animating the avatar body model to depict motion of the virtual character in a virtual environment.

One general aspect includes a system that includes a memory with instructions stored thereon; and a processing device coupled to the memory, the processing device configured to access the memory and execute the instructions, where the execution of the instructions cause the processing device to perform operations that may include obtaining a three-dimensional (3D) mesh of a virtual character, wherein the 3D mesh includes a plurality of vertices with respective positions in 3D space with one or more connections between the vertices, generating, based on the 3D mesh, an avatar body model for the virtual character, wherein the avatar body model includes a skinned 3D mesh, a plurality of body part meshes, and cage meshes corresponding to respective body part meshes of the plurality of body part meshes, wherein the generating includes generating a skeleton for the virtual character based on the 3D mesh, wherein the skeleton includes a plurality of joints connected by respective bones, wherein individual joints of the plurality of joints are pre-defined joints based on a body type of the virtual character, associating each of the plurality of joints of the skeleton to at least one respective vertex of the plurality of vertices of the 3D mesh to obtain the skinned 3D mesh, wherein a respective skinning weight is assigned to each vertex of the plurality of vertices, segmenting the skinned 3D mesh, based on the skinning weights associated with the plurality of vertices, into the plurality of body part meshes that correspond to respective body parts of the virtual character, and determining the cage mesh for each body part mesh, and animating the avatar body model to depict motion of the virtual character in a virtual environment.

### BRIEF DESCRIPTION OF THE DRAWINGS

FIG. 1 is a diagram of an example environment to generate an avatar body model based on a three-dimensional (3D) mesh of an avatar to be rendered on a computing device, in accordance with some implementations.

FIG. 2A depicts an example of an end-to-end workflow to generate an avatar body model based on a 3D mesh of the avatar, in accordance with some implementations.

FIG. 2B depicts an example system architecture utilized to generate an avatar body model based on a 3D mesh of the avatar, in accordance with some implementations.

FIG. 3 illustrates an example method to generate an avatar body model based on a 3D mesh of the avatar, in accordance with some implementations.

FIG. 4 is a schematic that illustrates an example of skeleton generation based on a 3D mesh of a virtual character, in accordance with some implementations.

FIG. 5 illustrates example stages during the generation of a skeleton hierarchy for an avatar based on a 3D mesh of the avatar, in accordance with some implementations.

FIG. 6 is a schematic that illustrates generation of skinning weights for an avatar, in accordance with some implementations.

FIG. 7 is a schematic that illustrates generation of body part meshes for an avatar based on a 3D mesh of the avatar, in accordance with some implementations.

FIG. 8 illustrates example stages during the generation of a body part mesh for an avatar, in accordance with some implementations.

FIG. 9 is a schematic that illustrates generation of cage meshes, in accordance with some implementations.

FIG. 10 illustrates an example computing device, in accordance with some implementations.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. Aspects of the present disclosure, as generally described herein, and illustrated in the Figures, can be arranged, substituted, combined, separated, and designed in a wide variety of different configurations, all of which are contemplated herein.

References in the specification to “some embodiments”, “an embodiment”, “an example embodiment”, etc. indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, such feature, structure, or characteristic may be effected in connection with other embodiments whether or not explicitly described.

Online virtual experience platforms (also referred to as “user-generated content platforms” or “user-generated content systems”) offer a variety of ways for users to interact with one another. For example, users of an online virtual experience platform may work together towards a common goal, share various virtual experience items, send electronic messages to one another, and so forth. Users of an online virtual experience platform may join virtual experience(s), e.g., games or other experiences as virtual characters, playing specific roles. For example, a virtual character may be part of a team or multiplayer environment wherein each character is assigned a certain role and has associated parameters, e.g., clothing, armor, weaponry, skills, etc. that correspond to the role. In another example, a virtual character may be joined by computer-generated characters, e.g., when a single player is part of a game.

A virtual experience platform may enable users (developers) of the platform to create objects, new games, and/or characters. For example, users of the online gaming platform may be enabled to create, design, and/or customize new characters (avatars), new animation packages, new three-dimensional objects, etc. and make them available to other users.

On some virtual platforms, developer users may generate and/or upload three-dimensional (3D) models of virtual characters or avatars, e.g., meshes and/or textures of avatars, for use in a virtual experience and for trade, barter, or sale on an online marketplace. The models may be utilized and/or modified by other users. The model can include 3D meshes that represent the geometry of the object and include vertices and define edges and faces. The model may additionally include UV maps and/or textures that define properties of a surface of the virtual character, e.g., skin complexion, tattoos, etc.

A virtual experience platform may also allow users of the platform to create and animate new characters and avatars. For example, users of the virtual experience platform may be enabled to create, design, customize, and animate new characters.

In some implementations, animation may include characters that move one or more body parts to simulate movement such as walking, running, jumping, dancing, fighting, wielding a weapon such as a sword, etc. In some implementations, avatars may generate facial expressions, where a part of a body, e.g., a face, is depicted in motion. In some scenarios, movement of the entire body of the character may be depicted. Animations may correspond to various movements, e.g., graceful, warrior-like, balletic, etc.

In some implementations, animation of a virtual character may be performed by rendering a sequence of images to create the illusion of motion of one or more parts of the virtual character. In some implementations, particular frames may be utilized to define the starting and ending points of an object or virtual character's motion in an animation. Interpolation between the particular frames may be performed to determine a sequence of frames (images) that may then be rendered, e.g., on a display device. In some implementations, each of the particular frames may include vertices of a 3D mesh of the virtual character.

In some implementations, a virtual experience platform may include support for animatable 3D models. Rigging in 3D objects such as avatars, e.g., humanoids, animals, birds etc., is based on an underlying skeletal structure. The animatable models may include an internal rig, or bone structure, that drives the deformation of the viewable geometry associated with the virtual character. The bone structure can include multiple bones that can be moved or deformed to enable various types of expressions and/or motion of the avatar. For example, animation of a virtual character to depict a smile of the virtual character may be performed by translating vertices of the 3D mesh that correspond to the ends of the mouth in opposite directions by a specified amount. Similarly, animation depicting an avatar walking or running may be performed via movement of vertices of the mesh of the avatar body in a direction of movement along with deformation of vertices of limbs of the avatar to mimic walking/running movement.

In some implementations, developer users may store various bone deformations as individual poses. In some implementations, animation may be performed by combining the individual poses to create expressions and animations.

In some implementations, rigging of an avatar may be performed which involves associating the geometry of a polygonal mesh or implicit surface to be driven by an underlying bone structure. This conveys the effect of deformation and/or motion of an avatar based on the motion of the underlying bone structure.

Rigging of 3D objects such as characters (avatars) can utilize standardized rigs (skeletons), e.g., R6 based virtual characters (with 6 joints for an avatar body), R15 based virtual characters (with 15 joints for an avatar body), etc., that are fitted to a surface geometry of an avatar to provide an underlying structure. In some implementations, the rigging of the avatar may be automatically performed. An objective of rigging of avatars is to generate aesthetically pleasing geometric deformations of the avatar based on the motion of the skeleton.

In some implementations, animation routines from one virtual character may be usable for other virtual characters, e.g., when they share a common morphology. In some implementations, the virtual experience platform may provide a set of standardized animation routines for use on the platform.

In some implementations, a virtual experience platform may provide support for the use of accessories for avatars. For example, avatars may be equipped with accessories such as shirts, pants, hats, etc. Accordingly, support may be provided for a cage mesh that delineates (demarcates) inner and outer surfaces of a layered accessory. In some implementations, each body part of an avatar may be associated with a respective cage mesh part.

In some implementations, the cage mesh may include an inner cage and an outer cage that enables an accessory asset to stretch, fit, and layer over a target avatar and/or any existing clothing items already worn by the avatar. For example, an inside cage of a t-shirt may define how the t-shirt stretches and fits over an avatar body while an outer cage of a t-shirt defines how any additional layered clothing items may fit over the t-shirt.

An avatar body model commonly includes a 3D mesh, a skeleton structure and/or hierarchy that can support animation of the avatar via deformation of vertices of the mesh, and support for accessories via a cage mesh that surrounds the 3D mesh of the avatar body.

A technical objective in automatic generation of avatar body models is to associate a 3D geometry of an avatar with an underlying skeleton, to automatically segment the 3D model into constituent body parts, and to generate a cage mesh compatible with the avatar body. Once generated, the avatar body model can be utilized to provide an immersive experience on a virtual experience platform that includes animation of the avatar as well as its accessorization.

A challenge in computer graphics and virtual experience (e.g., game) design, is the process of automatically generating an avatar body model based on a 3D mesh of the avatar. In many scenarios, content creators (developers) may start with a mesh of a virtual avatar that accurately represents the surface features of the avatar, e.g., outer shape/geometry of the avatar, texture of the avatar, etc. However, a 3D mesh of the avatar by itself is insufficient to provide a complete immersive experience since the 3D mesh cannot automatically be animated, or suitably accessorized.

For a superior user experience, the 3D mesh must be suitably rigged, skinned, segmented into respective body parts, along with generation of a cage mesh that corresponds to the different body parts. Segmentation of a 3D mesh of an avatar into different body parts, e.g., torso, hands, legs, head, etc., and determining a corresponding cage mesh for each body part enables better customization and more realistic depiction of the avatar, particularly for humanoid avatars.

Rigging of an avatar involves the determination of a skeleton hierarchy, a set of joints connected by bones that are utilized to simulate limb movement of the avatar. Skinning of the avatar refers to determination of skinning weights associated with respective vertices of the 3D mesh of the avatar and which are utilized to determine an amount of deformation of a vertex caused by deformation of one or more joints of the avatar. Accurate determination of the skeleton and skinning weights is needed for accurate simulation of the avatar, when subjected to external and/or internal forces. However, the rigging and skinning process can be time-consuming and arduous, requiring manual work, thereby impeding the ability of the developer to efficiently rig and skin a 3D mesh. Rigging and skinning via human intervention requires specialized knowledge about geometry processing, 3D modeling, and simulation of body mechanics. This can present a challenge to novice users, and even experienced users may face challenges in achieving suitable and accurate customization of an avatar.

The automatic pipeline described herein can enable a larger set of developer users (including those with limited or no skills in avatar body model generation) to create customized and complete avatar body models.

An objective of a virtual experience platform provider is the provision of realistic depiction of virtual characters (avatars), and particularly the physical behavior of avatars. An additional objective is to provide tools to content creators that can enable them to generate custom virtual characters (avatars)

A technical problem is the provision of automatic, accurate, scalable, cost-effective, and reliable tools for creation (generation) and editing of avatars. Techniques described herein may be utilized to provide a scalable and adaptive technical solution for the generation of avatar body models. In some implementations, an automatic pipeline may include a first stage that accepts as input a 3D mesh or geometry representing the avatar. The first stage may include skeleton generation that is followed by a second stage where skinning weights associated with vertices of the 3D mesh are determined. Subsequently, segmentation of the 3D mesh into individual body part meshes may be performed based on the skinning weights. Finally, cage meshes corresponding to individual body parts of the avatar may be determined. Additionally, in some implementations, a preprocessing stage may be performed to combine multiple texture images into a single texture image.

Per techniques of this disclosure, an avatar body model is automatically generated for an avatar based on a 3D mesh of the avatar. The generation process includes multiple stages whereby the avatar body model of the avatar (e.g., a fully rigged skeleton of the avatar that includes skinning weights, segmented body part meshes, and corresponding cage meshes) can be generated from a 3D mesh of the avatar that includes only a geometric representation of the avatar.

In some implementations, skeleton generation rigging is performed based on a simplified 3D mesh of the avatar by applying a trained machine learning model. The trained machine learning model is applied by providing vertex positions, topological edges and geodesic edges as input features to the model to obtain predicted vertex offsets (perturbed vertices) for the vertices relative to potential joint locations (positions). Based on the obtained vertex offsets, a set of joint locations for the avatar is obtained by performing one or more post-processing stages. The post processing stages may include filtering out vertices that are positioned outside of the 3D mesh, filtering out vertices that are isolated from other vertices, mirroring the perturbed vertices across a plane of symmetry to emulate joint symmetry, and clustering the vertices.

In some implementations, the set of joint locations may be validated, e.g., by utilizing a heuristic technique. Upon successful validation of the set of joint locations, the joints may be connected to respective bones to generate a skeleton hierarchy. If the joint locations are determined to not be valid, a procedural geometric skeleton generation technique may be applied. In some implementations, a default skeleton may be created based on the bounding box of the input 3D mesh and utilized to determine the skeleton hierarchy.

A skinning module may be utilized to generate skinning weights for each vertex based on the input 3D mesh and a skeleton hierarchy. In some implementations, the skeleton hierarchy may be automatically generated, as described herein. The input 3D mesh may be merged to ensure that there are no disconnected components. The merged 3D mesh is decimated to obtain a fewer number of vertices. During the decimation, a mapping between the decimated vertices and the original vertices of the merged 3D mesh is stored for subsequent retrieval.

The skinning model may utilize a second trained ML model, wherein a volumetric geodesic distance (e.g., a shortest path between two vertices in the 3D mesh) is provided as an input feature to the second trained ML model. Predicted skinning weights are obtained from the second trained ML model and transferred to the original merged 3D mesh based on the mapping generated during the decimation.

One or more post processing techniques may be applied to improve the smoothness of the predicted skinning weights. The post-processing techniques may include neighbor filtering, whereby mis-predicted skinning weights that bind vertices to unconnected joints are filtered out; outlier removal, whereby a flood fill technique is applied to filter out any mis-predicted weights that create islands; and average smoothing, whereby skinning weights for each vertex are smoothened by averaging the weights of its neighboring vertices.

Based on the skinning weights associated with each vertex of a 3D mesh of an avatar, the 3D mesh may be segmented into distinct body part meshes associated with respective body parts. In some implementations, the skinning weights may include skinning weights that are automatically determined based on techniques described herein.

In some implementations, interpolated boundaries (“ideal borders”) between respective parts may be identified based on the skinning weights assigned to the vertices. To avoid adding new geometry and edges, mesh edges closest to the interpolated borders are identified and culled to obtain a list of edges that include only significant contiguous loops (“proximity loops”) of connected vertices.

Guided by the proximity loops, smooth loops of vertices may be constructed by applying shortest-path techniques. Accordingly, the 3D mesh is considered to be a graph, where each mesh edge is a pair of directed graph edges. A smooth loop is determined based on an optimization of a distance of each vertex to the proximity loop as well as visual smoothness, where visual smoothness is computed as a factor of the surface angle between an edge and its preceding edge. To ensure that a smooth loop travels around the volume of the 3D mesh, a chirality of each directed edge is matched as the loop is being extended. The 3D mesh of the avatar is then divided at the smooth edge loops to create corresponding body part meshes, and hemispheres added at the holes to create end caps for each body part mesh.

In some implementations, a cage envelope may be automatically generated based on a segmented body mesh, e.g., a segmented body mesh generated at a previous stage of a processing pipeline. A point cloud is generated based on vertices in the input 3D mesh. A trained third ML model is utilized with the vertex positions, normals, and part identifier (e.g., a body part that a particular vertex belongs to) provided as input features. The third ML model includes an encoder-decoder model, wherein the encoder model operates directly on the point cloud, and the decoder includes stacked convolutional layers to regress global features generated from the encoder. The output of the trained third ML model is a point cloud corresponding to the cage vertices in canonical order.

Cage mesh parts are generated based on the respective vertices and their canonical connectivities. In some implementations, a post processing stage may be utilized to deform the predicted cage by adjusting a position of cage vertices that lie inside the mesh surface.

In some implementations, the techniques may be utilized within a tool, e.g., a studio tool that may be utilized by developers to process 3D mesh assets of avatars that have been generated based on descriptions, e.g., textual prompts, voice prompts, sketches, etc. In some implementations, the tool may support creators to create asset body models, e.g., for avatars where the 3D models (e.g., 3D meshes) have been created by the user, as well as for 3D models (3D meshes) provided via the virtual experience platform, 3D meshes obtained or purchased from other users, etc.

In some implementations, the techniques described herein may be utilized by a virtual experience platform to enable users to modify properties of a 3D object, during their participation in a virtual experience, thereby enabling creators and players to customize 3D objects based on their preferences. This can enable in-experience creation wherein users (e.g., non-developer users) can utilize the techniques to customize 3D objects for their virtual experience.

In some implementations, iterative refinement of the avatar body model may be performed based on modified descriptors, e.g., text prompts, received from a user. For example, in scenarios where the initial generation of the avatar body model does not meet a user's expectation, iterative refinement may be utilized to provide additional mesh customization via an interactive approach. During this iterative process, users can provide text prompts, e.g., to introduce additional descriptions for the avatar, avatar body parts, etc. This may enable the users to steer the creative direction and achieve a satisfactory result for avatar body model customization.

In some implementations, support may be provided for multiple types of input modalities from a user. For example, there may be scenarios where some portions of the avatar body model may be generated (designed) by the user, whereas a remainder of the portions of the avatar body model may be automatically generated using the techniques described herein. For example, a skeleton hierarchy may be specified by a user while the skinning weights for the vertices may be automatically determined.

Techniques described herein can be utilized to enable creation of user-generated avatar bodies by a broad set of users. Non-expert creators can be enabled to be successful in creating and uploading their own functional and beautiful avatars, even with limited experience in 3D animation and rigging.

Techniques described herein introduce a new approach to the generation of animation ready avatars that can enable users to create a wide variety of virtual characters that are animatable and with support for accessories such as layered clothing. The automated processes contribute to more efficient and accessible 3D mesh customization of avatars, promoting creativity and enabling a wider range of users to create virtual characters with ease.

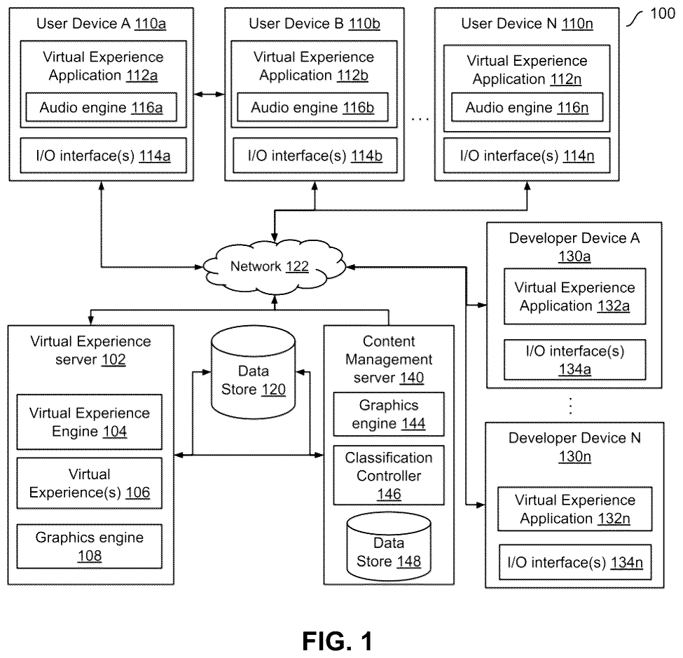

FIG. 1 is a diagram of an example environment to generate an avatar body model based on a three-dimensional (3D) mesh of an avatar to be rendered on a computing device, in accordance with some implementations. FIG. 1 and other figures use like reference numerals to identify like elements. A letter after a reference numeral, such as “110,” indicates that the text refers specifically to the element having that particular reference numeral. A reference numeral in the text without a following letter, such as “110,” refers to any or all of the elements in the figures bearing that reference numeral (e.g. “110” in the text refers to reference numerals “110a,” “110b,” and/or “110n” in the figures).

The system architecture 100 (also referred to as “system” herein) includes online virtual experience server 102, data store 120, user devices 110a, 110b, and 110n (generally referred to as “user device(s) 110” herein), and developer devices 130a and 130n (generally referred to as “developer device(s) 130” herein), virtual experience server 102, content management server 140, data store 120, user devices 110, and developer devices 130 are coupled via network 122. In some implementations, user devices(s) 110 and developer device(s) 130 may refer to the same or same type of device.

Online virtual experience server 102 can include a virtual experience engine 104, one or more virtual experience(s) 106, and graphics engine 108. A user device 110 can include a virtual experience application 112, and input/output (I/O) interfaces 114 (e.g., input/output devices). The input/output devices can include one or more of a microphone, speakers, headphones, display device, mouse, keyboard, game controller, touchscreen, virtual reality consoles, etc. The input/output devices can also include accessory devices that are connected to the user device by means of a cable (wired) or that are wirelessly connected.

Content management server 140 can include a graphics engine 144, and a classification controller 146. In some implementations, the content management server may include a plurality of servers. In some implementations, the plurality of servers may be arranged in a hierarchy, e.g., based on respective prioritization values assigned to content sources.

Graphics engine 144 may be utilized for the rendering of one or more objects, e.g., 3D objects associated with the virtual environment. Classification controller 146 may be utilized to classify assets such as 3D objects and for the detection of inauthentic digital assets, etc. Data store 148 may be utilized to store a search index, model information, etc.

A developer device 130 can include a virtual experience application 132, and input/output (I/O) interfaces 134 (e.g., input/output devices). The input/output devices can include one or more of a microphone, speakers, headphones, display device, mouse, keyboard, game controller, touchscreen, virtual reality consoles, etc.

System architecture 100 is provided for illustration. In different implementations, the system architecture 100 may include the same, fewer, more, or different elements configured in the same or different manner as that shown in FIG. 1.

In some implementations, network 122 may include a public network (e.g., the Internet), a private network (e.g., a local area network (LAN) or wide area network (WAN)), a wired network (e.g., Ethernet network), a wireless network (e.g., an 802.11 network, a Wi-Fi® network, or wireless LAN (WLAN)), a cellular network (e.g., a 5G network, a Long Term Evolution (LTE) network, etc.), routers, hubs, switches, server computers, or a combination thereof.

In some implementations, the data store 120 may be a non-transitory computer readable memory (e.g., random access memory), a cache, a drive (e.g., a hard drive), a flash drive, a database system, a cloud storage system, or another type of component or device capable of storing data. The data store 120 may also include multiple storage components (e.g., multiple drives or multiple databases) that may also span multiple computing devices (e.g., multiple server computers).

In some implementations, the online virtual experience server 102 can include a server having one or more computing devices (e.g., a cloud computing system, a rackmount server, a server computer, cluster of physical servers, etc.). In some implementations, the online virtual experience server 102 may be an independent system, may include multiple servers, or be part of another system or server.

In some implementations, the online virtual experience server 102 may include one or more computing devices (such as a rackmount server, a router computer, a server computer, a personal computer, a mainframe computer, a laptop computer, a tablet computer, a desktop computer, a distributed computing system, a cloud computing system, etc.), data stores (e.g., hard disks, memories, databases), networks, software components, and/or hardware components that may be used to perform operations on the online virtual experience server 102 and to provide a user with access to online virtual experience server 102. The online virtual experience server 102 may also include a website (e.g., a web page) or application back-end software that may be used to provide a user with access to content provided by online virtual experience server 102. For example, users may access online virtual experience server 102 using the virtual experience application 112 on user devices 110.

In some implementations, online virtual experience server 102 may be a type of social network providing connections between users or a type of user-generated content system that allows users (e.g., end-users or consumers) to communicate with other users on the online virtual experience server 102, where the communication may include voice chat (e.g., synchronous and/or asynchronous voice communication), video chat (e.g., synchronous and/or asynchronous video communication), or text chat (e.g., synchronous and/or asynchronous text-based communication). In some implementations of the disclosure, a “user” may be represented as a single individual. However, other implementations of the disclosure encompass a “user” (e.g., creating user) being an entity controlled by a set of users or an automated source. For example, a set of individual users federated as a community or group in a user-generated content system may be considered a “user.”

In some implementations, online virtual experience server 102 may be an online gaming server. For example, the virtual experience server may provide single-player or multiplayer games to a community of users that may access or interact with games using user devices 110 via network 122. In some implementations, games (also referred to as “video game,” “online game,” or “virtual game” herein) may be two-dimensional (2D) games, three-dimensional (3D) games (e.g., 3D user-generated games), virtual reality (VR) games, or augmented reality (AR) games, for example. In some implementations, users may participate in gameplay with other users. In some implementations, a game may be played in real-time with other users of the game.

In some implementations, gameplay may refer to the interaction of one or more players using user devices (e.g., 110) within a game (e.g., game that is part of virtual experience 106) or the presentation of the interaction on a display or other output device (e.g., 114) of a user device 110.

In some implementations, a virtual experience 106 can include an electronic file that can be executed or loaded using software, firmware or hardware configured to present the game content (e.g., digital media item) to an entity. In some implementations, a virtual experience application 112 may be executed and a virtual experience 106 executed in connection with a virtual experience engine 104. In some implementations, a virtual experience (e.g., a game) 106 may have a common set of rules or common goal, and the environment of a virtual experience 106 shares the common set of rules or common goal. In some implementations, different games may have different rules or goals from one another.

In some implementations, virtual experience(s) may have one or more environments (also referred to as “gaming environments” or “virtual environments” herein) where multiple environments may be linked. An example of an environment may be a three-dimensional (3D) environment. The one or more environments of a virtual experience application 112 may be collectively referred to a “world” or “gaming world” or “virtual world” or “universe” herein. An example of a world may be a 3D world of a virtual experience 106. For example, a user may build a virtual environment that is linked to another virtual environment created by another user. A character of the virtual game may cross the virtual border to enter the adjacent virtual environment.

It may be noted that 3D environments or 3D worlds use graphics that use a three-dimensional representation of geometric data representative of game content (or at least present game content to appear as 3D content whether or not 3D representation of geometric data is used). 2D environments or 2D worlds use graphics that use two-dimensional representation of geometric data representative of game content.

In some implementations, the online virtual experience server 102 can host one or more virtual experiences 106 and can permit users to interact with the virtual experiences 106 using a virtual experience application 112 of user devices 110. Users of the online virtual experience server 102 may play, create, interact with, or build virtual experiences 106, communicate with other users, and/or create and build objects (e.g., also referred to as “item(s)” or “game objects” or “virtual game item(s)” herein) of virtual experiences 106. For example, in generating user-generated virtual items, users may create characters, decoration for the characters, one or more virtual environments for an interactive game, or build structures used in a game. In some implementations, users may buy, sell, or trade virtual game objects, such as in-platform currency (e.g., virtual currency), with other users of the online virtual experience server 102. In some implementations, online virtual experience server 102 may transmit game content to virtual experience applications (e.g., 112). In some implementations, game content (also referred to as “content” herein) may refer to any data or software instructions (e.g., game objects, game, user information, video, images, commands, media item, etc.) associated with online virtual experience server 102 or virtual experience applications. In some implementations, game objects (e.g., also referred to as “item(s)” or “objects” or “virtual objects” or “virtual game item(s)” herein) may refer to objects that are used, created, shared or otherwise depicted in virtual experiences 106 of the online virtual experience server 102 or virtual experience applications 112 of the user devices 110. For example, game objects may include a part, model, character, accessories, tools, weapons, clothing, buildings, vehicles, currency, flora, fauna, components of the aforementioned (e.g., windows of a building), and so forth.

It may be noted that the online virtual experience server 102 hosting virtual experiences 106, is provided for purposes of illustration, rather than limitation. In some implementations, online virtual experience server 102 may host one or more media items that can include communication messages from one user to one or more other users. Media items can include, but are not limited to, digital video, digital movies, digital photos, digital music, audio content, melodies, website content, social media updates, electronic books, electronic magazines, digital newspapers, digital audio books, electronic journals, web blogs, real simple syndication (RSS) feeds, electronic comic books, software applications, etc. In some implementations, a media item may be an electronic file that can be executed or loaded using software, firmware or hardware configured to present the digital media item to an entity.

In some implementations, a virtual application 106 may be associated with a particular user or a particular group of users (e.g., a private game), or made widely available to users with access to the online virtual experience server 102 (e.g., a public game). In some implementations, where online virtual experience server 102 associates one or more virtual experiences 106 with a specific user or group of users, online virtual experience server 102 may associate the specific user(s) with a virtual experience 106 using user account information (e.g., a user account identifier such as username and password).

In some implementations, online virtual experience server 102 or user devices 110 may include a virtual experience engine 104 or virtual experience application 112. In some implementations, virtual experience engine 104 may be used for the development or execution of virtual experiences 106. For example, virtual experience engine 104 may include a rendering engine (“renderer”) for 2D, 3D, VR, or AR graphics, a physics engine, a collision detection engine (and collision response), sound engine, scripting functionality, animation engine, artificial intelligence engine, networking functionality, streaming functionality, memory management functionality, threading functionality, scene graph functionality, or video support for cinematics, among other features. The components of the virtual experience engine 104 may generate commands that help compute and render the game (e.g., rendering commands, collision commands, physics commands, etc.) In some implementations, virtual experience applications 112 of user devices 110, may work independently, in collaboration with virtual experience engine 104 of online virtual experience server 102, or a combination of both.

In some implementations, both the online virtual experience server 102 and user devices 110 may execute a virtual experience engine and a virtual experience application (104 and 112, respectively). The online virtual experience server 102 using virtual experience engine 104 may perform some or all the virtual experience engine functions (e.g., generate physics commands, rendering commands, etc.), or offload some or all the virtual experience engine functions to virtual experience engine 104 of user device 110. In some implementations, each virtual application 106 may have a different ratio between the virtual experience engine functions that are performed on the online virtual experience server 102 and the virtual experience engine functions that are performed on the user devices 110. For example, the virtual experience engine 104 of the online virtual experience server 102 may be used to generate physics commands in cases where there is a collision between at least two virtual application objects, while the additional virtual experience engine functionality (e.g., generate rendering commands) may be offloaded to the user device 110. In some implementations, the ratio of virtual experience engine functions performed on the online virtual experience server 102 and user device 110 may be changed (e.g., dynamically) based on gameplay conditions. For example, if the number of users participating in gameplay of a particular virtual application 106 exceeds a threshold number, the online virtual experience server 102 may perform one or more virtual experience engine functions that were previously performed by the user devices 110.

For example, users may be playing a virtual application 106 on user devices 110, and may send control instructions (e.g., user inputs, such as right, left, up, down, user election, or character position and velocity information, etc.) to the online virtual experience server 102. Subsequent to receiving control instructions from the user devices 110, the online virtual experience server 102 may send gameplay instructions (e.g., position and velocity information of the characters participating in the group gameplay or commands, such as rendering commands, collision commands, etc.) to the user devices 110 based on control instructions. For instance, the online virtual experience server 102 may perform one or more logical operations (e.g., using virtual experience engine 104) on the control instructions to generate gameplay instruction(s) for the user devices 110. In other instances, online virtual experience server 102 may pass one or more or the control instructions from one user device 110 to other user devices (e.g., from user device 110a to user device 110b) participating in the virtual application 106. The user devices 110 may use the gameplay instructions and render the gameplay for presentation on the displays of user devices 110.

In some implementations, the control instructions may refer to instructions that are indicative of in-game actions of a user's character. For example, control instructions may include user input to control the in-game action, such as right, left, up, down, user selection, gyroscope position and orientation data, force sensor data, etc. The control instructions may include character position and velocity information. In some implementations, the control instructions are sent directly to the online virtual experience server 102. In other implementations, the control instructions may be sent from a user device 110 to another user device (e.g., from user device 110b to user device 110n), where the other user device generates gameplay instructions using the local virtual experience engine 104. The control instructions may include instructions to play a voice communication message or other sounds from another user on an audio device (e.g., speakers, headphones, etc.), for example voice communications or other sounds generated using the audio spatialization techniques as described herein.

In some implementations, gameplay instructions may refer to instructions that allow a user device 110 to render gameplay of a game, such as a multiplayer game. The gameplay instructions may include one or more of user input (e.g., control instructions), character position and velocity information, or commands (e.g., physics commands, rendering commands, collision commands, etc.).

In some implementations, the online virtual experience server 102 may store characters created by users in the data store 120. In some implementations, the online virtual experience server 102 maintains a character catalog and game catalog that may be presented to users. In some implementations, the game catalog includes images of virtual experiences stored on the online virtual experience server 102. In addition, a user may select a character (e.g., a character created by the user or another user) from the character catalog to participate in the chosen game. The character catalog includes images of characters stored on the online virtual experience server 102. In some implementations, one or more of the characters in the character catalog may have been created or customized by the user. In some implementations, the chosen character may have character settings defining one or more of the components of the character.

In some implementations, a user's character can include a configuration of components, where the configuration and appearance of components and more generally the appearance of the character may be defined by character settings. In some implementations, the character settings of a user's character may at least in part be chosen by the user. In other implementations, a user may choose a character with default character settings or character setting chosen by other users. For example, a user may choose a default character from a character catalog that has predefined character settings, and the user may further customize the default character by changing some of the character settings (e.g., adding a shirt with a customized logo). The character settings may be associated with a particular character by the online virtual experience server 102.

In some implementations, the virtual experience platform may support three-dimensional (3D) objects that are represented by a 3D model and includes a surface representation used to draw the character or object (also known as a skin or mesh) and a hierarchical set of interconnected bones (also known as a skeleton or rig). The rig may be utilized to animate the object and to simulate motion of the object. The 3D model may be represented as a data structure, and one or more parameters of the data structure may be modified to change various properties of the character, e.g., dimensions (height, width, girth, etc.); shape; movement style; number/type of parts; proportion, etc.

In some implementations, the 3D model may include a 3D mesh. The 3D mesh may define a three-dimensional structure of the unauthenticated virtual 3D object. In some implementations, the 3D mesh may also define one or more surfaces of the 3D object. In some implementations, the 3D object may be a virtual avatar, e.g., a virtual character such as a humanoid character, an animal-character, a robot-character, etc.

In some implementations, the mesh may be received (imported) in a FBX file format. The mesh file includes data that provides dimensional data about polygons that comprise the virtual 3D object and UV map data that describes how to attach portions of texture to various polygons that comprise the 3D object. In some implementations, the 3D object may correspond to an accessory, e.g., a hat, a weapon, a piece of clothing, etc. worn by a virtual avatar or otherwise depicted with reference to a virtual avatar.

In some implementations, a platform may enable users to submit (upload) candidate 3D objects for utilization on the platform. A virtual experience development environment (developer tool) may be provided by the platform, in accordance with some implementations. The virtual experience development environment may provide a user interface that enables a developer user to design and/or create virtual experiences, e.g., games. The virtual experience development environment may be a client-based tool (e.g., downloaded and installed on a client device, and operated from the client device), a server-based tool (e.g., installed and executed at a server that is remote from the client device, and accessed and operated by the client device), or a combination of both client-based and service-based elements.

The virtual experience development environment may be operated by a developer of a virtual experience, e.g., a game developer or any other person who seeks to create a virtual experience that may be published by an online virtual experience platform and utilized by others. The user interface of the virtual experience development environment may be rendered on a display screen of a client device, e.g., such as a developer device 130 described with reference to FIG. 1, so as to enable the creator/developer to interact with the development environment using actions such as typing, highlighting, selecting, drag and drop, clicking, and so forth via a mouse, keyboard, or other input device configured to communicate with the user interface. The user interface may include a menu bar, a tool bar, a workspace pane, and a plurality of secondary panes. Depending on the particular implementation, the user interface may include alternative or additional elements, arrangements, operational features, etc. of the virtual experience development environment than what is shown and described herein.

A developer user (creator) may utilize the virtual experience development environment to create virtual experiences. As part of the development process, the developer/creator may upload various types of digital content such as object files (meshes), image files, audio files, short videos, etc., to enhance the virtual experience.

In implementations where the 3D object is an accessory, data indicative of use of the object in a virtual experience may also be received. For example, a “shoe” object may include annotations indicating that the object can be depicted as being worn on the feet of a virtual humanoid character, while a “shirt” object may include annotations that it may be depicted as being worn on the torso of a virtual humanoid character.

In some implementations, the 3D model may further include texture information associated with the 3D object. For example, texture information may indicate color and/or pattern of an outer surface of the 3D object. The texture information may enable varying degrees of transparency, reflectiveness, degrees of diffusiveness, material properties, and refractory behavior of the textures and meshes associated with the 3D object. Examples of textures include plastic, cloth, grass, a pane of light blue glass, ice, water, concrete, brick, carpet, wood, etc.

In some implementations, the user device(s) 110 may each include computing devices such as personal computers (PCs), mobile devices (e.g., laptops, mobile phones, smart phones, tablet computers, or netbook computers), network-connected televisions, gaming consoles, etc. In some implementations, a user device 110 may also be referred to as a “client device.” In some implementations, one or more user devices 110 may connect to the online virtual experience server 102 at any given moment. It may be noted that the number of user devices 110 is provided as illustration. In some implementations, any number of user devices 110 may be used.

In some implementations, each user device 110 may include an instance of the virtual experience application 112, respectively. In one implementation, the virtual experience application 112 may permit users to use and interact with online virtual experience server 102, such as control a virtual character in a virtual game hosted by online virtual experience server 102, or view or upload content, such as virtual experiences 106, images, video items, web pages, documents, and so forth. In one example, the virtual experience application may be a web application (e.g., an application that operates in conjunction with a web browser) that can access, retrieve, present, or navigate content (e.g., virtual character in a virtual environment, etc.) served by a web server. In another example, the virtual experience application may be a native application (e.g., a mobile application, app, or a gaming program) that is installed and executes local to user device 110 and allows users to interact with online virtual experience server 102. The virtual experience application may render, display, or present the content (e.g., a web page, a media viewer) to a user. In an implementation, the virtual experience application may also include an embedded media player (e.g., a Flash® player) that is embedded in a web page.

In some implementations, the virtual experience application may include an audio engine 116 that is installed on the user device, and which enables the playback of sounds on the user device. In some implementations, audio engine 116 may act cooperatively with audio engine 144 that is installed on the sound server.

According to aspects of the disclosure, the virtual experience application may be an online virtual experience server application for users to build, create, edit, upload content to the online virtual experience server 102 as well as interact with online virtual experience server 102 (e.g., participate in virtual experiences 106 hosted by online virtual experience server 102). As such, the virtual experience application may be provided to the user device(s) 110 by the online virtual experience server 102. In another example, the virtual experience application may be an application that is downloaded from a server.

In some implementations, each developer device 130 may include an instance of the virtual experience application 132, respectively. In one implementation, the virtual experience application 132 may permit a developer user(s) to use and interact with online virtual experience server 102, such as control a virtual character in a virtual game hosted by online virtual experience server 102, or view or upload content, such as virtual experiences 106, images, video items, web pages, documents, and so forth. In one example, the virtual experience application may be a web application (e.g., an application that operates in conjunction with a web browser) that can access, retrieve, present, or navigate content (e.g., virtual character in a virtual environment, etc.) served by a web server. In another example, the virtual experience application may be a native application (e.g., a mobile application, app, or a virtual experience program) that is installed and executes local to user device 130 and allows users to interact with online virtual experience server 102. The virtual experience application may render, display, or present the content (e.g., a web page, a media viewer) to a user. In an implementation, the virtual experience application may also include an embedded media player (e.g., a Flash® player) that is embedded in a web page.

According to aspects of the disclosure, the virtual experience application 132 may be an online virtual experience server application for users to build, create, edit, upload content to the online virtual experience server 102 as well as interact with online virtual experience server 102 (e.g., provide and/or play virtual experiences 106 hosted by online virtual experience server 102). As such, the virtual experience application may be provided to the user device(s) 130 by the online virtual experience server 102. In another example, the virtual experience application 132 may be an application that is downloaded from a server. Virtual experience application 132 may be configured to interact with online virtual experience server 102 and obtain access to user credentials, user currency, etc. for one or more virtual applications 106 developed, hosted, or provided by a virtual experience application developer.

In some implementations, a user may login to online virtual experience server 102 via the virtual experience application. The user may access a user account by providing user account information (e.g., username and password) where the user account is associated with one or more characters available to participate in one or more virtual experiences 106 of online virtual experience server 102. In some implementations, with appropriate credentials, a virtual experience application developer may obtain access to virtual experience application objects, such as in-platform currency (e.g., virtual currency), avatars, special powers, accessories, that are owned by or associated with other users.

In general, functions described in one implementation as being performed by the online virtual experience server 102 can also be performed by the user device(s) 110, or a server, in other implementations if appropriate. In addition, the functionality attributed to a particular component can be performed by different or multiple components operating together. The online virtual experience server 102 can also be accessed as a service provided to other systems or devices through appropriate application programming interfaces (APIs), and thus is not limited to use in websites.

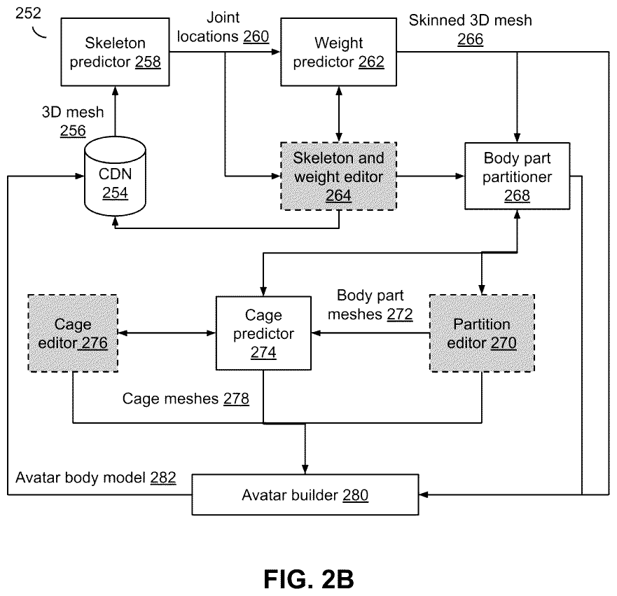

In some implementations, online virtual experience server 102 may include a graphics engine 108. In some implementations, the graphics engine 108 may be a system, application, or module that permits the online virtual experience server 102 to provide graphics and animation capability. In some implementations, the graphics engine 108, and/or content management server 140 may perform one or more of the operations described below in connection with the flowcharts and workflows shown in FIG. 3.

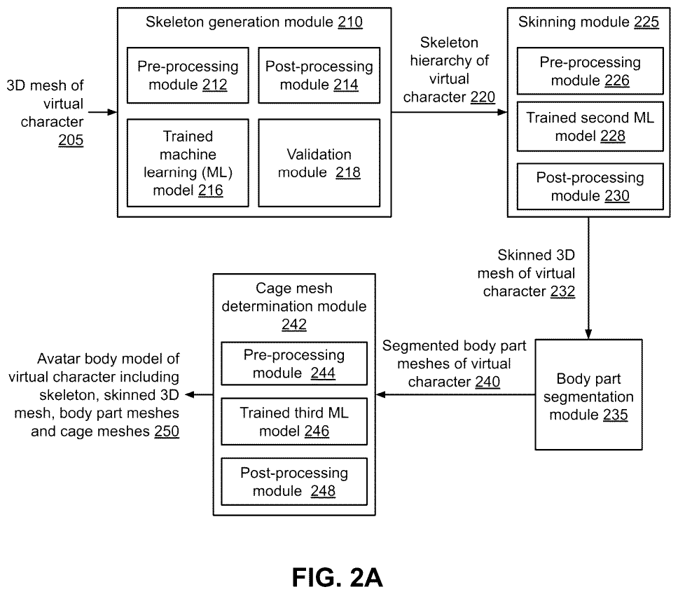

FIG. 2A depicts an example of an end-to-end workflow to generate an avatar body model based on a 3D mesh of the avatar, in accordance with some implementations.

As depicted in FIG. 2A, the workflow includes providing a 3D mesh of a virtual character (avatar) 205 to a skeleton generation module 210. The segmentation module may include a pre-processing module 212, a post-processing module 214, a trained machine learning model 216 (also referred to as first trained machine learning model 216), and validation module 218. The skeleton generation module 210 outputs a skeleton hierarchy of the virtual character 220. The skeleton hierarchy 220 is provided to a skinning module 225. The constraint graph determination module 225 includes a pre-processing module 226, a trained second ML model 228, and post-processing module 230, and generates a skinned 3D mesh of the virtual character 232.

The input 3D mesh of the virtual character 232 is provided to a body part segmentation module 235. The body part segmentation module 235 generates segmented body part meshes of the virtual character 240, which is provided to cage mesh determination nodule 242.

Cage mesh determination module 242 includes a pre-processing module 244, a trained third ML model 246, and a post-processing module 248.

The output of the workflow is an avatar body model of the virtual character 250 that includes a skeleton, a skinned 3D mesh, body part meshes corresponding to different body parts, and corresponding cage meshes.

FIG. 2B depicts an example system architecture utilized to generate an avatar body model based on a 3D mesh of the avatar, in accordance with some implementations.

As depicted in FIG. 2B, a content delivery network (CDN) 254 is utilized to store digital assets associated with virtual characters (avatars). A 3D mesh 256 is obtained from CDN 254 and provided to a skeleton predictor 258, which may be utilized to implement, for example, skeleton generation nodule 210, described with reference to FIG. 2A. Skeleton predictor 258 may be utilized to predict joint locations 260, which may be provided to (skinning) weight predictor 262. In some implementations, the predicted joint location may be adjusted via a skeleton and weight editor 264, which may enable manual adjustment and editing of the skeleton and skinning weights.

A skinned 3D mesh 266 that includes a skeleton hierarchy and skinning weights is provided to body part partitioner 268, which may be utilized to implement, for example, body segmentation module 235 described with reference to FIG. 2A.

The body part partitioner 268 may be utilized to generate body part meshes 272 based on the skinned 3D mesh 266. The body part meshes 272 may be provided to cage predictor 274, and alternatively (optionally) to a partition editor 270 which may enable direct editing of the body part meshes 272, e.g., by developer users who may want to adjust/edit the body part meshes 272.

The cage predictor 274 may be utilized to implement, for example, cage mesh determination module 242 described with reference to FIG. 2A. Cage meshes 278 generated by cage predictor 274 may be provided to avatar builder 280, which is also provided with the skinned 3D mesh 266. In some implementations, the cage meshes 278 may be provided to a cage editor 276 for manual editing of the cage meshes.

The avatar builder 280 generates an avatar body model 282 that may be stored at CDN 252.

FIG. 3 illustrates an example method to generate an avatar body model based on a 3D mesh of the avatar, in accordance with some implementations.

In some implementations, method 300 can be implemented, for example, on virtual experience 102 described with reference to FIG. 1. In some implementations, some or all portions of the method 300 can be implemented on one or more client devices 110 as shown in FIG. 1, on one or more developer devices 130, or on one or more server device(s) 102, and/or on a combination of developer device(s), server device(s), and client device(s). In described examples, the implementing system includes one or more digital processors or processing circuitry (“processors”), and one or more storage devices (e.g., a database 120 or other storage). In some implementations, different components of one or more servers and/or clients can perform different blocks or other parts of the method 300. In some examples, a first device is described as performing blocks of method 300. Some implementations can have one or more blocks of method 300 performed by one or more other devices (e.g., other client devices or server devices) that can send results or data to the first device.

In some implementations, the method 300, or portions of the method, can be initiated automatically by a system. In some implementations, the implementing system is a first device. For example, the method (or portions thereof) can be periodically performed, or performed based on one or more particular events or conditions, e.g., a request received from a user to generate an avatar body model for an avatar, receiving a 3D mesh of a virtual character (avatar) at the virtual experience platform, a predetermined time period having expired since the last performance of method 300, and/or one or more other conditions occurring which can be specified in settings read by the method. Method 300 may begin at block 310.

At block 310, a three-dimensional (3D) mesh of a virtual character that includes a plurality of vertices and edges is obtained. In some implementations, the 3D mesh includes a plurality of vertices with respective positions in 3D space with one or more connections between the vertices. In some implementations, the virtual character may be a humanoid character and includes portions that correspond to a head, torso, arms, and legs.

In some implementations, the 3D mesh may be uploaded by a user to a virtual experience platform with an intent to generate an avatar body model. In some implementations, the virtual experience platform may enable users to submit (upload) 3D meshes of the 3D objects for utilization on the platform. In some implementations, one or more textures associated with the 3D mesh may be provided. In some implementations, the 3D mesh may include descriptors and/or labels associated with different portions of the 3D mesh that may provide a description or identifier of the different portions. In some other implementations, the 3D mesh may not include any additional descriptors or labels.

The 3D mesh is a representation (e.g., a mathematical model) of the geometry of the virtual character (avatar). In some implementations, the 3D mesh may define one or more surfaces of the avatar. In some implementations, the 3D object may be a humanoid avatar.

In some implementations, the 3D mesh may be generated by applying a generative machine learning (gen-ML) model to a user provided prompt, e.g., a text prompt, a voice prompt, a sketch, etc., that specifies elements of an avatar to be generated. Tools provided by the virtual experience platform may enable users to apply the gen-ML techniques to generate avatar meshes based on provided descriptions.

A virtual experience development environment (developer tool) may be provided by the platform, in accordance with some implementations. In some implementations, the 3D mesh may be received (imported) in a FBX file format. The mesh file may include data that provides dimensional data about polygons that comprise the virtual 3D object and UV map data that describes how to attach portions of texture to various polygons that comprise the 3D object.

In some implementations, based on the 3D mesh, an avatar body model for the virtual character may be automatically generated. In some implementations, the avatar body model includes a skinned 3D mesh, a plurality of body part meshes, and cage meshes corresponding to respective body part meshes of the plurality of body part meshes.

In some implementations, prior to generating the avatar body model, a received 3D mesh may be simplified to reduce a vertex count of the 3D mesh. Additionally, the simplifying may include one or more operations that include filtering, clean-up, or mirroring of the mesh vertices.

In some implementations, prior to generating the avatar body model, a pre-processing stage may be utilized wherein one or more textures (e.g., UV maps) associated with a received 3D mesh may be merged into a single texture image. A UV map of the received 3D mesh may be modified suitably to match the merged texture image.

Block 310 may be followed by block 320.

At block 320, based on the 3D mesh, a skeleton of an avatar body model of the virtual character is generated that includes a plurality of joints. In some implementations, generating the skeleton for the virtual character may include generating a skeleton that includes a plurality of joints connected by respective bones. Each joint may be defined by a joint location, which may be specified using a reference frame (e.g., coordinate axes) common to the skeleton and the 3D mesh.

In some implementations, the individual joints of the plurality of joints may be pre-defined joints that are defined based on a body type of the virtual character. For example, in some implementations, 15 joints may be pre-defined for a humanoid character. In some implementations, the 15 joints may include a neck joint, a torso joint, 2 shoulder joints, 2 elbow joints, 2 wrist joints, 2 hip joints, 2 knee joints, 2 ankle joints, and a root joint. In different implementations, different numbers of joints and body parts may be pre-defined, depending on the particular implementation.

In some implementations, prior to generation of the skeleton, a received 3D mesh may be normalized by repositioning the bounding box of the received 3D mesh to a standardized (predetermined) size. In some implementations, a received 3D mesh (e.g., a 3D mesh uploaded by a user) may be simplified by remeshing to adjust its topology and optionally, decimated, to reduce a number of vertices in the received 3D mesh. Mesh simplification may reduce added noise from local features on the 3D mesh and may enable more accurate skeleton generation.

In some implementations, the skeleton may be generated by applying a trained machine learning model to the 3D mesh to obtain predicted joint locations of the plurality of joints of the skeleton. In some implementations, vertex positions, topological edges, and geodesic edges of the 3D mesh may be provided as input to the trained machine learning model.

In some implementations, the trained machine learning model may be a graph convolution neural network that is trained to generate vertex offsets for each vertex in a 3D mesh towards potential joint locations. Based on the input features, the trained machine learning model may provide as output a respective predicted offset (distance) of a nearest joint location from the vertex.

Based on the predicted joint locations, a skeleton hierarchy for the virtual character may be determined. In some implementations, prior to determining (building) the skeleton hierarchy, one or more post-processing operations may be performed. In some implementations, the post-processing operations may include removing one or more vertices that lie external to a bounding box of the 3D mesh, removing one or more vertices that are isolated, mirroring the vertices across a plane of symmetry, and combinations thereof.

For example, in some implementations, as part of the postprocessing, vertices that are located outside of the body mesh may be excluded (filtered), as are outlier vertices that are located greater than a threshold distance from any of the other vertices. For example, a distance between pairs of vertices may be calculated and vertices whose minimum distance to other vertices are larger than a certain threshold may be filtered out.

In some implementations, the postprocessing may include mirroring, whereby vertices are mirrored around an axis, e.g., a Y axis, thereby doubling a number of vertices. Subsequent to applying filtering and mirroring, the vertices may be clustered into different groups and a center of each group of vertices may be selected as a final joint location (position) for a particular joint.

In some implementations, the post-processing operations may further include clustering the predicted joint locations to generate the skeleton. For example, K-means clustering and/or mean shift clustering techniques may be utilized to group the perturbed vertices obtained from the trained ML model into clusters and a cluster center of each cluster may be selected as a respective joint location.

In some implementations, the determined joint locations may be validated prior to building a skeleton hierarchy for the virtual avatar. In some implementations, it may be determined, based on a heuristic technique, whether the predicted joint locations of the plurality of joints are valid.

In some implementations, determining the validity of the joints may include verifying relative positions of each joint (predicted joint). In some implementations, the validations may include verifying whether joints located on the spine, e.g., head, upper torso, and lower torso joints, form a relatively straight line (e.g., can be fitted to a straight line while meeting a predetermined error criterion). Additionally, it may be verified whether the shoulder joints are higher than lower arm and hands joints, and/or whether the hip joints (e.g., upper leg joint) lies above knee and feet joints (e.g., lower leg joint(s) and feet joint(s)).

If it is determined that the predicted joint locations are valid, the plurality of joints may be connected to bones to determine the skeleton hierarchy. If it is determined that the predicted joint locations are invalid, the skeleton hierarchy may be determined based on one of a procedurally generated geometric skeleton and a default skeleton.

For example, in some implementations, if it is determined that the predicted joint locations are invalid, the skeleton hierarchy may be determined by applying a procedural geometry generation technique to the 3D mesh. A further validation may be performed, and if it is further determined that the predicted joint locations are invalid, a default skeleton may be utilized to determine the skeleton hierarchy. In some implementations, a type of virtual character and its dimensions may be utilized to select a suitable default skeleton, e.g., from a set of default skeletons.

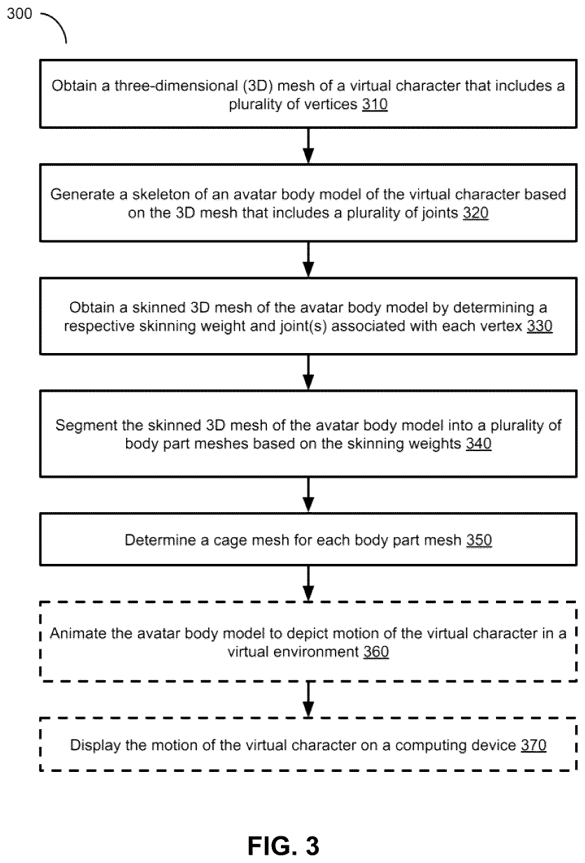

FIG. 4 is a schematic that illustrates an example of skeleton generation based on a 3D mesh of a virtual character, in accordance with some implementations.

As depicted in FIG. 4, an input 3D mesh 410 of a virtual character (avatar) is provided to a remesh and decimation module 420. A simplified 3D mesh 325 is obtained after remeshing and decimation and provided to a trained ML model 430. Based on input features obtained from the simplified 3D mesh 425, predicted joint locations 432 are determined by utilizing the ML model 430.

Post-processing 440 may be performed on the predicted joint locations 432. The post-processing 440 may include filtering 442, mirroring 444, and clustering 446.

Joint locations 448 obtained subsequent to performing post-processing 440 are validated by validation module 450. In some implementations, a manual editing tool 452 may be provided to adjust joint locations.

If it is determined that the predicted joint locations are valid, the joint locations may be connected to bones to determine the skeleton hierarchy 460. If it is determined that the joint locations do not meet predetermined validation criteria, procedural generation 454 or a selection of a suitable skeleton from a set of default skeletons 456 may be utilized to determine the skeleton hierarchy 460.

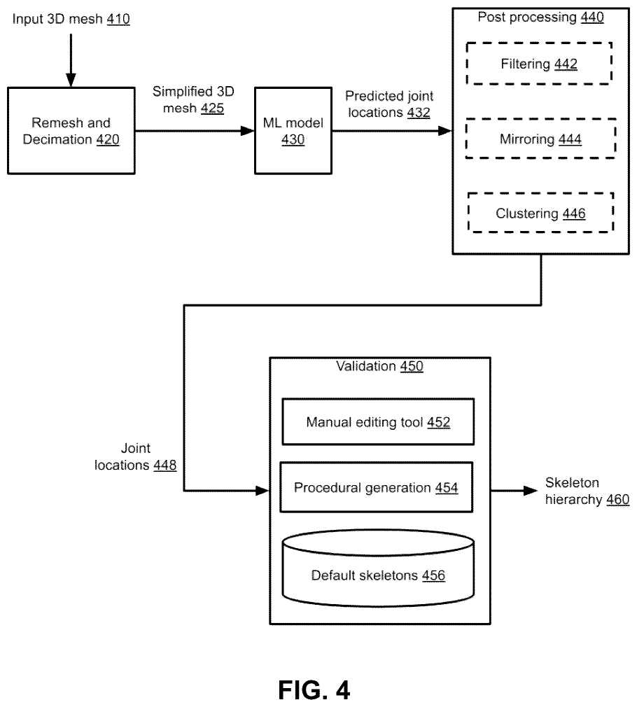

FIG. 5 illustrates example stages during the generation of a skeleton hierarchy for an avatar based on a 3D mesh of the avatar, in accordance with some implementations.

FIG. 5 depicts a 3D mesh of a virtual character at a first stage 510 subsequent to inference of joint locations based on a trained ML model that includes a set of predicted joint locations 515, a second stage 540 subsequent to performing filtering and mirroring 520 that includes a set of joint locations 545, and a third stage 570 subsequent to performing clustering and validation 550 that include joint locations 585 connected by bones 580.

Based on input features provided as input to a trained ML model, a set of predicted joint locations 515 is inferred by the trained ML model, e.g., based on predicted vertex offsets.

In some implementations, method 300 may further include training the ML model (e.g., the graph convolution neural network). In some implementations, training comprises training the ML model on a training dataset that includes 3D meshes of avatars and joint locations, skeletons and/or skeleton hierarchies corresponding to the 3D meshes of the avatars. The training dataset may be generated by humans, or from automatically constructed 3D meshes that are constructed from various combinations of known bones and/or skeletons. Block 320 may be followed by block 330.

At block 330, a skinned 3D mesh of the avatar body model is obtained by determining a respective skinning weight and joint(s) associated with each vertex of the skinned 3D mesh.

In some implementations, the skinning weights are determined based on the skeleton hierarchy, e.g., a skeleton hierarchy determined at block 320 and may be represented as a weight vector per mesh vertex indicative of a degree of influence received by the vertex from different bones in the 3D mesh of the avatar.

In some implementations, obtaining the skinned 3D mesh may include associating each of the plurality of joints to at least one respective vertex of the plurality of vertices of the 3D mesh to obtain the skinned 3D mesh, wherein a respective skinning weight is assigned to each vertex of the plurality of vertices.

In some implementations, the 3D mesh may be mapped to a decimated 3D mesh, wherein two or more vertices of the 3D mesh correspond to a single vertex of the decimated 3D mesh. In some implementations, the decimation may be performed by applying a quadric mesh simplification technique. In some implementations, a mapping utilized to perform the decimation is stored for subsequent retrieval.

The reason to merge and decimate the mesh first is to improve the accuracy and reduce the runtime of computing the volumetric geodesic distance used as input feature for ML.

In some implementations, prior to performing the decimation, an input 3D mesh may be merged to ensure that there are no disconnected components in the input 3D mesh. For example, in some scenarios, a received 3D mesh of a virtual character (avatar) may include cuts or seams that may need to be repaired. The cuts and/or seams may be due to errors introduced during mesh generation, as well as be an artifact of another technique (process) that may have split the 3D mesh into parts as a rendering optimization.

In some implementations, prior to performing the decimation, seams of a #D mesh may be adjusted such that the topology is continuous. For example, in some scenarios, an input 3D mesh may include multiple disconnected components, e.g., multiple separate 3D meshes. For example, an arm may be modeled as three different meshes, an upper arm mesh, a lower arm mesh and a head. The vertices in each of the meshes may not be connected to vertices in other meshes. In some implementations, in order to resolve the disconnectivity, merging may be performed to combine multiple separate meshes into one mesh, whereby there is a path between every single vertex to other vertices.

In some implementations, a trained second machine learning model may be applied to the decimated 3D mesh to determine intermediate skinning weights for the decimated 3D mesh. In some implementations, a respective volumetric geodesic distance between individual pairs of vertices and bones is provided as an input feature to the trained second ML model. The output from the trained second ML model may include intermediate skinning weights for each vertex of the decimated 3D mesh.

Based on the mapping previously utilized during the decimation of the 3D mesh, the skinning weights for each vertex of the (original, undecimated) 3D mesh may be calculated based on the intermediate skinning weights and the mapping.

In some implementations, additional post-processing may be performed based on the skinning weights to determine a final set of skinning weights. The post-processing may include smoothening the skinning weights by neighbor filtering, outlier removal, and average smoothing.

In some implementations, neighbor filtering may be utilized to identify and filter out vertices that may be assigned with mis-predicted weights, e.g., vertices that are predicted to bind to unconnected joints. For example, if a predicted skinning weight of a vertex is determined to be 0.7 relative to a head joint and determined to be 0.3 relative to a foot joint, it may be inferred that the skinning weights associated with the foot joint (the 0.3 weight) is a mis-prediction since the head joint and foot joint are not directly connected. Accordingly, the weight on the foot joint may be removed (e.g., set to zero) and the remainder of the skinning weights are renormalized.

In some implementations, outlier removal may be utilized to identify and filter out outlier vertices. Vertices assigned with a maximum skinning weight for a joint are expected to form a single island (e.g., a closed loop that connects vertices assigned with a particular skinning weight). Consequently, each joint of the virtual character is expected to have one corresponding island of vertices that are assigned the maximum skinning weight for that joint. However, in some scenarios, the predicted skinning weights may lead to the formation of more than one island for a specific joint. In such a scenario, it may be inferred that the smaller islands are mispredictions. Accordingly, the smaller islands are removed and skinning weights for vertices of the removed islands are flood-filled with the skinning weights assigned to a neighboring island (e.g., a neighboring island of vertices that includes a largest number of included vertices).

In some implementations, every vertex is assigned (e.g., grouped into) to a set of vertices, based on a joint associated with the maximum skinning weight for the vertex. Topologically connected vertices that are in the same set of vertices are considered as an island. If multiple islands are identified for the same vertex, smaller islands are removed, by flooding them with the skinning weights associated with boundary vertices of the smaller islands.

In some implementations, average smoothing may be performed whereby skinning weights for each vertex is smoothed by being set to an average of the skinning weights of its neighboring vertices.

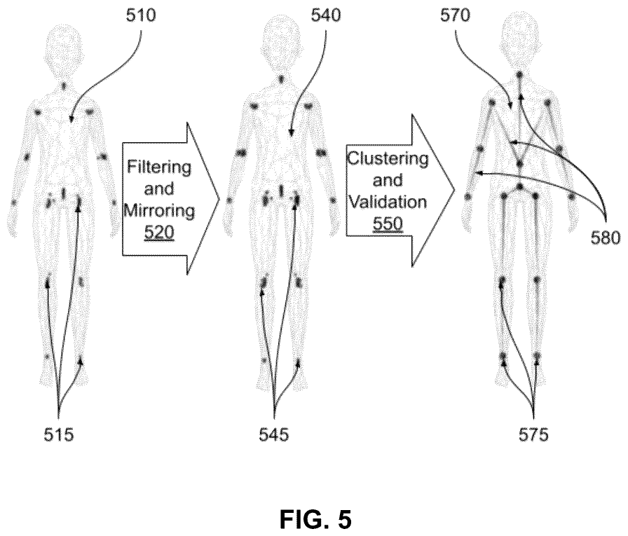

FIG. 6 is a schematic that illustrates generation of skinning weights for an avatar, in accordance with some implementations.

As depicted in FIG. 6, an input 3D mesh 610 of a virtual character and a skeleton hierarchy 612 are provided to a merging module 615. A merged mesh 620 is provided to a decimation module 622, where it is decimated such that a number of vertices in the decimated mesh 624 is fewer than a number of vertices in the input 3D mesh 610. A mapping 626 utilized to perform the decimation may be stored (saved) for subsequent retrieval.

The decimated mesh 624 is provided to a trained ML model 630, which generates intermediate skinning weights 632, which are then transferred to the original merged mesh 635.

One or more post-processing 640 operations may be performed, which include neighbor filtering 645, outlier removal 650, and average smoothing 655 to generate skinning weights per vertex 660.

In some implementations, method 300 may further include training the second ML model 630 with a training dataset. In some implementations, the training of the second ML model may be performed by utilizing a training dataset that includes 3D meshes and skinning weights associated with the 3D meshes. In some implementations, the training dataset may be created based on 3D meshes available on the virtual experience platform, e.g., meshes of avatars that have been previously created and uploaded to the platform. Block 330 may be followed by block 340.

At block 340, the skinned 3D mesh of the avatar body model is segmented into a plurality of body part meshes based on the skinning weights. In some implementations, each of the body part meshes may correspond to a respective body part of the virtual character, e.g., head, torso, left leg, right leg, etc.

In some implementations, segmenting the skinned 3D mesh into the plurality of body part meshes may include determining vertices of the skinned 3D mesh associated with each body part based on the skinning weights, and segmenting the skinned 3D mesh into a plurality of body part meshes, each body part mesh including respective vertices associated with the body part. In some implementations, an end cap may be generated and added to a body part mesh for a hole that may be created by the segmentation.

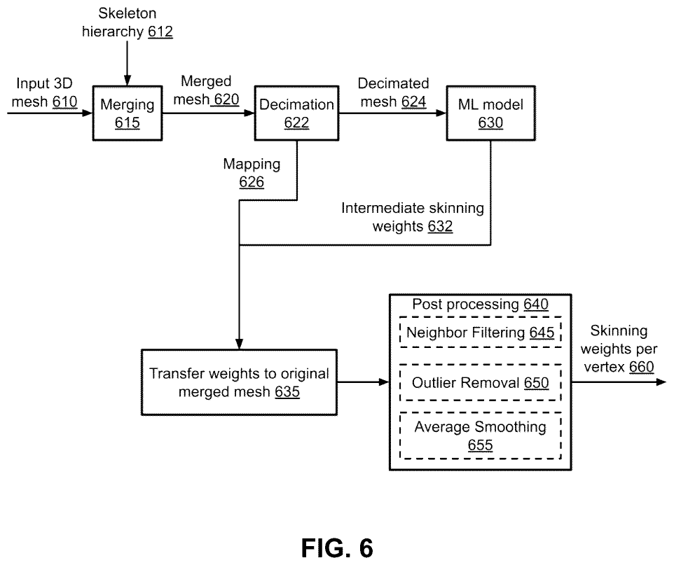

FIG. 7 is a schematic that illustrates generation of body part meshes for an avatar based on a 3D mesh of the avatar, in accordance with some implementations.

As depicted in FIG. 7, an input 3D mesh 710 and skinning weights 720 are utilized to determine interpolated boundaries 730 between body parts. In some implementations, the interpolated boundaries may be referred to as “ideal boundaries” and may be indicative of a boundary between body parts as determined by skinning weights alone.

In some implementations, the vertices of a 3D mesh may be gathered into sets of vertices based on a joint that exerts a maximum influence on the vertex. For example, all vertices where a head joint exerts a maximum influence on the vertex may be grouped into a single set of vertices. The input 3D mesh may be partitioned at the boundaries between these sets of vertices.

In some implementations, a cage may be generated and temporary weights assigned to each vertex in a cage. The boundary between the cages may be utilized to split the 3D mesh into respective parts. Utilization of a cage based approach may enable the location of the split to align better with the clothing, e.g., a waist of the avatar may be split exactly at the belt location.

In some implementations, iso-weight lines (lines that connect vertices with the same skinning weights) on the mesh surface may be utilized to separate the 3D mesh into parts. The iso-weight lines may be indicative of boundary lines where the mesh transitions between bones have the maximum influence.

Based on the interpolated boundaries, proximate boundaries may be determined 740, whereby mesh edges in the input 3D mesh that lie closest to the interpolated (ideal) boundaries are selected as a proximate boundary. In some implementations, a loop created by connecting vertices along a proximate boundary may be referred to as a proximity loop.

Based on the proximate boundary, a smooth boundary (smooth loops) may be determined (constructed) 750 such that a boundary between respective body part meshes meets a predetermined smoothness criterion. In some implementations, a smooth loop may be determined from a proximate boundary by applying a shortest-path technique. In some implementations, determining smooth loops may include identifying any islands formed by the interpolated boundaries and excluding the islands during determination of the smooth loops.

In some implementations, determining a smooth loop may include applying a graph theoretic technique to the 3D mesh. In some implementations, each mesh edge is considered to be a pair of directed graph edges. A distance to the proximity loop from each vertex and a smoothness factor (that is associated with visual smoothness) are optimized, where a smoothness factor is computed as a factor of the surface angle between an edge and its preceding edge.

In some implementations, the smoothness factor is computed during traversal between a traversed edge and each preceding edge. In some implementations, directed edges may be utilized during the traversal since traversing an edge in one direction may yield superior results when compared to an opposite direction.

In some implementations, excessive computational cycles are prevented by discarding edges whose leading paths include themselves. In some implementations, in order to ensure that the smooth loop travels around the volume of the mesh, a chirality of each directed edge is matched.

Based on the smooth boundary, body part meshes may be generated that correspond to a respective body part. Any holes created by the separation of the body part meshes are plugged by hemispherical end caps that are created 770. This has the effect of creating closed body part meshes.

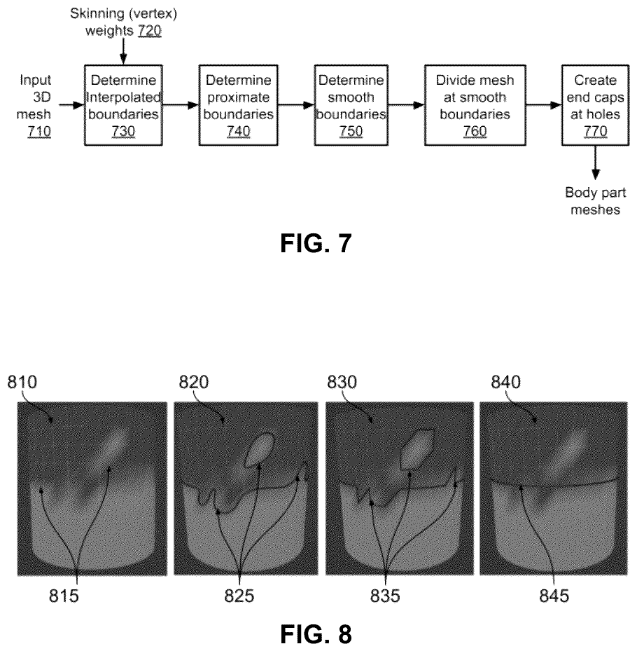

FIG. 8 illustrates example stages during the generation of a body part mesh for an avatar, in accordance with some implementations.

In this illustrative example, a boundary between two body parts is depicted as it is refined between a first stage 810, a second stage 820, a third stage 830, and a final stage 840.

As depicted in FIG. 8, skinning weights of mesh vertices are utilized to demarcate portions of the mesh with different values of skinning weights. For example, areas 815 includes vertices with a different value for skinning weights when compared to the other vertices (the different shades are indicative of a difference in skinning weights in the different portions of the 3D mesh) at the first stage 810.

An interpolated boundary 825 is depicted at a second stage 820 formed based on a boundary identified between the portions with different levels of skinning weights,

At the third stage 830, mesh edges closest to the interpolated boundary 825 are selected to create a proximate boundary 835. Based on the proximate boundary 835, a smooth boundary 845 is determined at a final stage 840. The smooth boundary 845 may be utilized to partition a single 3D mesh into body part meshes associated with a respective portion of the 3D mesh.

The combination of the skeleton (and skeleton hierarchy) and the skinning weights is usable to animate and simulate motion of the avatar in a virtual environment. Block 340 may be followed by block 350.

At block 350, a cage mesh is determined for each body part mesh of a plurality of body part meshes. In some implementations, determining the cage mesh for each body part mesh may include determining a cage mesh that surrounds the input 3D mesh that includes a segmented plurality of body parts.

In some implementations, determining the cage mesh may include applying a trained third machine learning model to the 3D mesh to determine a point cloud that includes a plurality of cage vertices and a canonical connectivity between the plurality of cage vertices. In some implementations, vertex positions, normals, and a type of the body part for each of the plurality of vertices in the body part mesh are provided as input features to the third trained machine learning model.

In some implementations, based on the plurality of cage vertices and the respective canonical connectivity for each cage vertex, a plurality of predicted cage mesh parts may be determined. Based on the plurality of cage mesh parts, a cage mesh for the virtual character may be determined by stitching together the individual cage meshes.

However, in some scenarios, some of the vertices of the predicted cage mesh parts may lie within a surface of the 3D mesh (body mesh) of the avatar. If such a scenario is encountered, vertices in the predicted cage mesh parts that lie inside the surface of the 3D mesh may be deformed from their initial predicted location to a location outside the surface of the 3D mesh.

In some implementations, applying the deformation may include applying an as-rigid-as-possible (ARAP) deformation technique, cage vertices that are located inside a mesh surface are set as hard constraints and their position is moved to outside of the surface of the 3D mesh of the virtual character (avatar). The remainder of the vertices (e.g., the cage vertices whose predicted location was outside of the 3D mesh follow the movement of the hard constraints and deform smoothly to determine a final set of cage vertices. The final cage mesh may then be split back into cage mesh parts associated with a respective body part mesh.

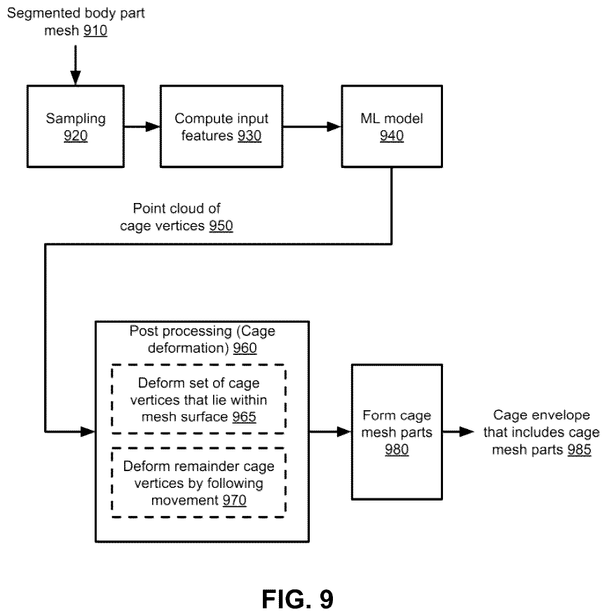

FIG. 9 is a schematic that illustrates generation of cage meshes, in accordance with some implementations.

As depicted in FIG. 9, a segmented body part mesh 910 is provided to a sampling module 920, where it is sampled to generate a point cloud. Input features are computed 930 based on the point cloud and provided to a trained third ML model 940. A point cloud of cage vertices 950 is obtained as output from the trained third ML model 940.

Post-processing 960 operations may be performed using the point cloud of cage vertices 950 and may include deformation of a first set of cage vertices that lie within the 3D mesh surface 965, e.g., based on applying an ARAP deformation. The remaining cage vertices (e.g., second set of cage vertices that lie outside the 3D mesh surface) may be deformed by following the movement of the first set of cage vertices.

In some implementations, based on a set of cage vertices obtained subsequent to performing post processing 960, cage mesh parts may be formed 980. A cage envelope that includes cage mesh parts 985 may be exported and stored.

In some implementations, user annotations may be used to enhance performance of the machine learning models utilized herein. For example, user provided descriptions, captions, labels, etc., may be utilized in segmenting the 3D mesh of the virtual character into body part meshes. In some implementations, a category or type of a virtual avatar may be determined by performing a broad classification of the virtual avatar, and the category of the 3D object may be utilized to aid method 300 described herein.

Block 350 may be followed by block 360.

At block 360, the avatar body model may be animated to depict motion of the virtual character in a virtual environment. In some implementations, the animation may utilize an animation routine provided by the virtual experience platform. In some other implementations, animation may utilize an animation routine provided by a user.

In some implementations, the animation may include determining respective deformations of one or more vertices of the 3D mesh based on an underlying skeleton and skinning weights associated with the one or more vertices.

In some implementations, an item of layered clothing represented by a corresponding 3D mesh may be attached to a cage vertex located on the cage mesh part of the 3D avatar body model. For example, a 3D mesh of a shirt may be attached to a cage vertex of a torso cage mesh of an avatar in order to depict the avatar wearing the shirt.

Block 360 may be followed by block 370.

At block 370, the avatar (virtual character) may be displayed, e.g., on a display screen. The avatar body model of the 3D object may be utilized for animation and determining images (frames) of the virtual environment that depict a state and motion of the avatar in the virtual environment.

Method 300, or portions thereof, may be repeated any number of times using additional inputs. Blocks 310-370 may be performed (or repeated) in a different order than described above and/or one or more steps can be omitted. For example, blocks 360-370 may be omitted in some implementations. In some implementations, blocks 320, 330, 340, and/or 350 may be performed by themselves without performing other blocks. For example, only blocks corresponding to skeleton generation, determining a skinned 3D mesh, or cage mesh generation, etc., may be performed based on corresponding inputs. Blocks 310-350 may be performed at different rates. For example, blocks 310-340 may be performed once when a 3D object mesh is received and blocks 350-360 may be performed multiple times based on a 3D mesh received/obtained at block 310. Additionally, blocks 320-350 may be repeated if it is determined that the 3D object has undergone changes in the virtual environment that may necessitate one or more parts of an avatar body model to be determined afresh.

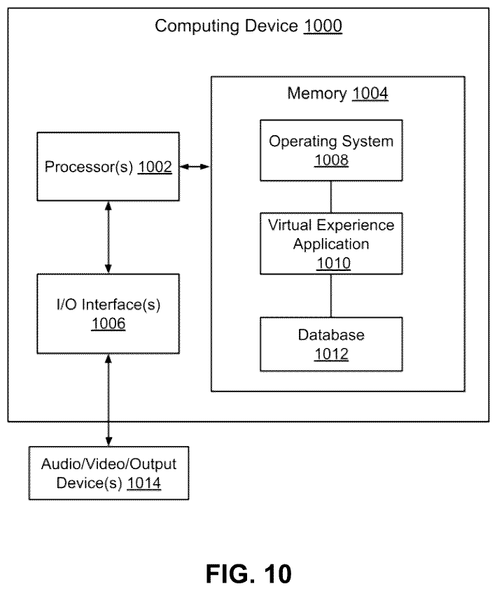

FIG. 10 illustrates an example computing device, in accordance with some implementations.

In one example, device 1000 may be used to implement a computer device (e.g., 102, 110, and/or 130 of FIG. 1), and perform suitable method implementations described herein. Computing device 1000 can be any suitable computer system, server, or other electronic or hardware device. For example, the computing device 1000 can be a mainframe computer, desktop computer, workstation, portable computer, or electronic device (portable device, mobile device, cell phone, smartphone, tablet computer, television, TV set top box, personal digital assistant (PDA), media player, game device, wearable device, etc.). In some implementations, device 1000 includes a processor 1002, a memory 1004, input/output (I/O) interface 1006, and audio/video input/output devices 1014.

Processor 1002 can be one or more processors, processing devices, and/or processing circuits to execute program code and control basic operations of the device 1000. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 1004 is typically provided in device 1000 for access by the processor 1002, and may be any suitable processor-readable storage medium, e.g., random access memory (RAM), read-only memory (ROM), Electrical Erasable Read-only Memory (EEPROM), Flash memory, etc., suitable for storing instructions for execution by the processor, and located separate from processor 1002 and/or integrated therewith. Memory 1004 can store software operating on the server device 1000 by the processor 1002, including an operating system 1008, one or more applications 1010, e.g., an audio spatialization application, a sound application, content management application, and application data 1012. In some implementations, application 1010 can include instructions that enable processor 1002 to perform the functions (or control the functions of) described herein, e.g., some or all of the methods described with respect to FIG. 3.

For example, applications 1010 can include an audio spatialization module which as described herein can provide audio spatialization within an online virtual experience server (e.g., 102). Any software in memory 1004 can alternatively be stored on any other suitable storage location or computer-readable medium. In addition, memory 1004 (and/or other connected storage device(s)) can store instructions and data used in the features described herein. Memory 1004 and any other type of storage (magnetic disk, optical disk, magnetic tape, or other tangible media) can be considered “storage” or “storage devices.”

I/O interface 1006 can provide functions to enable interfacing the server device 1000 with other systems and devices. For example, network communication devices, storage devices (e.g., memory and/or data store 120), and input/output devices can communicate via interface 1006. In some implementations, the I/O interface can connect to interface devices including input devices (keyboard, pointing device, touchscreen, microphone, camera, scanner, etc.) and/or output devices (display device, speaker devices, printer, motor, etc.).

The audio/video input/output devices 1014 can include a user input device (e.g., a mouse, etc.) that can be used to receive user input, a display device (e.g., screen, monitor, etc.) and/or a combined input and display device, that can be used to provide graphical and/or visual output.

For ease of illustration, FIG. 10 shows one block that is representative of each processor 1002, memory 1004, I/O interface 1006, and software blocks 1008 and 1010. These blocks may represent one or more processors, computing instances on distributed computing systems, processing devices, or processing circuitries, operating systems, memories, I/O interfaces, applications, and/or software engines. In other implementations, device 1000 may not have all of the components shown and/or may have other elements including other types of elements instead of, or in addition to, those shown herein. While the online virtual experience server 102 is described as performing operations as described in some implementations herein, any suitable component or combination of components of online virtual experience server 102 or similar system, or any suitable processor or processors associated with such a system, may perform the operations described.

A user device can also implement and/or be used with features described herein. Example user devices can be computer devices including some similar components as the device 1000, e.g., processor(s) 1002, memory 1004, and I/O interface 1006. An operating system, software and applications suitable for the user device can be provided in memory and used by the processor. The I/O interface for a user device can be connected to network communication devices, as well as to input and output devices, e.g., a microphone for capturing sound, a camera for capturing images or video, a mouse for capturing user input, a gesture device for recognizing a user gesture, a touchscreen to detect user input, audio speaker devices for outputting sound, a display device for outputting images or video, or other output devices. A display device within the audio/video input/output devices 1014, for example, can be connected to (or included in) the device 1000 to display images pre- and post-processing as described herein, where such display device can include any suitable display device, e.g., an LCD, LED, or plasma display screen, CRT, television, monitor, touchscreen, 3-D display screen, projector, or other visual display device. Some implementations can provide an audio output device, e.g., voice output or synthesis that speaks text.

One or more methods described herein (e.g., method 300, etc.) can be implemented by computer program instructions or code, which can be executed on a computer. For example, the code can be implemented by one or more digital processors (e.g., microprocessors or other processing circuitry), and can be stored on a computer program product including a non-transitory computer-readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g., Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating systems.

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a user device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Although the description has been described with respect to particular implementations thereof, these particular implementations are merely illustrative, and not restrictive. Concepts illustrated in the examples may be applied to other examples and implementations.

Note that the functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

What is claimed is:

1. A computer-implemented method, comprising:
obtaining a three-dimensional (3D) mesh of a virtual character, wherein the 3D mesh includes a plurality of vertices with respective positions in 3D space with one or more connections between the vertices;
generating, based on the 3D mesh, an avatar body model for the virtual character, wherein the avatar body model includes a skinned 3D mesh, a plurality of body part meshes, and cage meshes corresponding to respective body part meshes of the plurality of body part meshes, wherein the generating comprises:
generating a skeleton for the virtual character based on the 3D mesh, wherein the skeleton includes a plurality of joints connected by respective bones, wherein individual joints of the plurality of joints are pre-defined joints based on a body type of the virtual character;
associating each of the plurality of joints of the skeleton to at least one respective vertex of the plurality of vertices of the 3D mesh to obtain the skinned 3D mesh, wherein a respective skinning weight is assigned to each vertex of the plurality of vertices;
segmenting the skinned 3D mesh, based on the skinning weights associated with the plurality of vertices, into the plurality of body part meshes that correspond to respective body parts of the virtual character; and
determining the cage mesh for each body part mesh; and
animating the avatar body model to depict motion of the virtual character in a virtual environment.

2. The computer-implemented method of claim 1, further comprising:
receiving the 3D mesh of the virtual character; and
prior to generating the avatar body model, simplifying the 3D mesh to reduce a vertex count of the 3D mesh, wherein the simplifying comprises one or more of filtering, clean-up, or mirroring.

3. The computer-implemented method of claim 1, wherein generating the skeleton comprises:
applying a trained machine learning model to the 3D mesh to obtain predicted joint locations of the plurality of joints of the skeleton, wherein vertex positions, topological edges, and geodesic edges of the 3D mesh are provided as input to the trained machine learning model; and
building a skeleton hierarchy for the virtual character based on the predicted joint locations.

4. The computer-implemented method of claim 3, further comprising, prior to building the skeleton hierarchy, performing at least one operation from the group comprising: removing one or more vertices that lie external to a bounding box of the 3D mesh, removing one or more vertices that are isolated, mirroring the vertices across a plane of symmetry, and any combination thereof.

5. The computer-implemented method of claim 3, further comprising clustering the predicted joint locations to generate the skeleton.

6. The computer-implemented method of claim 3, wherein building the skeleton hierarchy comprises:
determining whether the predicted joint locations of the plurality of joints are valid;
if it is determined that the predicted joint locations are valid, connecting the plurality of joints to bones to determine the skeleton hierarchy; and
if it is determined that the predicted joint locations are invalid, determining the skeleton hierarchy based on one of a procedurally generated geometric skeleton and a default skeleton.

7. The computer-implemented method of claim 1, wherein the skinning weights are determined by:
mapping the 3D mesh to a decimated 3D mesh, wherein two or more vertices of the 3D mesh correspond to a single vertex of the decimated 3D mesh;
applying a trained second machine learning model to the decimated 3D mesh to determine intermediate skinning weights for the decimated 3D mesh, wherein a respective volumetric geodesic distance between individual pairs of vertices and bones are provided as input to the trained second machine learning model; and
calculating the skinning weights for each vertex of the 3D mesh based on the intermediate skinning weights and the mapping.

8. The computer-implemented method of claim 1, wherein segmenting the skinned 3D mesh into the plurality of body part meshes comprises:
determining vertices of the skinned 3D mesh associated with each body part based on the skinning weights.

9. The computer-implemented method of claim 1, wherein determining the cage mesh comprises, for each body part:
applying a trained third machine learning model to the body part mesh of the body part to determine a point cloud that includes a plurality of cage vertices and a canonical connectivity between the plurality of cage vertices;
forming a plurality of predicted cage mesh parts based on the plurality of vertices and the canonical connectivity for each vertex; and
determining the cage mesh by deforming vertices in the predicted cage mesh parts that lie inside a surface of the body mesh.

10. A non-transitory computer-readable medium with instructions stored thereon that, responsive to execution by a processing device, cause the processing device to perform operations comprising:
obtaining a three-dimensional (3D) mesh of a virtual character, wherein the 3D mesh includes a plurality of vertices with respective positions in 3D space with one or more connections between the vertices;
generating, based on the 3D mesh, an avatar body model for the virtual character, wherein the avatar body model includes a skinned 3D mesh, a plurality of body part meshes, and cage meshes corresponding to respective body part meshes of the plurality of body part meshes wherein the generating comprises:
generating a skeleton for the virtual character based on the 3D mesh, wherein the skeleton includes a plurality of joints connected by respective bones, wherein individual joints of the plurality of joints are pre-defined joints based on a body type of the virtual character;
associating each of the plurality of joints of the skeleton to at least one respective vertex of the plurality of vertices of the 3D mesh to obtain the skinned 3D mesh, wherein a respective skinning weight is assigned to each vertex of the plurality of vertices;
segmenting the skinned 3D mesh, based on the skinning weights associated with the plurality of vertices into the plurality of body part meshes that correspond to respective body parts of the virtual character; and
determining the cage mesh for each body part mesh; and
animating the avatar body model to depict motion of the virtual character in a virtual environment.

11. The non-transitory computer-readable medium of claim 10, wherein the operations further comprise:
receiving the 3D mesh of the virtual character; and
prior to generating the avatar body model, simplifying the 3D mesh to reduce a vertex count of the 3D mesh, wherein the simplifying comprises one or more of filtering, clean-up, or mirroring.

12. The non-transitory computer-readable medium of claim 10, wherein generating the skeleton comprises:
applying a trained machine learning model to the 3D mesh to obtain predicted joint locations of the plurality of joints of the skeleton, wherein vertex positions, topological edges, and geodesic edges of the 3D mesh are provided as input to the trained machine learning model; and
building a skeleton hierarchy for the virtual character based on the predicted joint locations.

13. The non-transitory computer-readable medium of claim 12, wherein the operations further comprise, prior to building the skeleton hierarchy, performing at least one operation from the group comprising: removing one or more vertices that lie external to a bounding box of the 3D mesh, removing one or more vertices that are isolated, mirroring the vertices across a line of symmetry, and any combination thereof.

14. The non-transitory computer-readable medium of claim 12, wherein building the skeleton hierarchy comprises:
determining whether the predicted joint locations of the plurality of joints are valid;
if it is determined that the predicted joint locations are valid, connecting the plurality of joints to bones to determine the skeleton hierarchy; and
if it is determined that the predicted joint locations are invalid, determining the skeleton hierarchy based on one of a procedurally generated geometric skeleton and a default skeleton.

15. The non-transitory computer-readable medium of claim 10, wherein the skinning weights are determined by:
mapping the 3D mesh to a decimated 3D mesh, wherein two or more vertices of the 3D mesh correspond to a single vertex of the decimated 3D mesh;
applying a trained second machine learning model to the decimated 3D mesh to determine intermediate skinning weights for the decimated 3D mesh, wherein a respective volumetric geodesic distance between individual pairs of vertices and bones are provided as input to the trained second machine learning model; and
calculating the skinning weights for each vertex of the 3D mesh based on the intermediate skinning weights and the mapping.

16. A system comprising:
a memory with instructions stored thereon; and
a processing device, coupled to the memory, the processing device configured to access the memory and execute the instructions, wherein the instructions cause the processing device to perform operations comprising:
obtaining a three-dimensional (3D) mesh of a virtual character, wherein the 3D mesh includes a plurality of vertices with respective positions in 3D space with one or more connections between the vertices;
generating, based on the 3D mesh, an avatar body model for the virtual character, wherein the avatar body model includes a skinned 3D mesh, a plurality of body part meshes, and cage meshes corresponding to respective body part meshes of the plurality of body part meshes wherein the generating comprises:
generating a skeleton for the virtual character based on the 3D mesh, wherein the skeleton includes a plurality of joints connected by respective bones, wherein individual joints of the plurality of joints are pre-defined joints based on a body type of the virtual character;
associating each of the plurality of joints of the skeleton to at least one respective vertex of the plurality of vertices of the 3D mesh to obtain the skinned 3D mesh, wherein a respective skinning weight is assigned to each vertex of the plurality of vertices;
segmenting the skinned 3D mesh, based on the skinning weights associated with the plurality of vertices into the plurality of body part meshes that correspond to respective body parts of the virtual character; and
determining the cage mesh for each body part mesh; and
animating the avatar body model to depict motion of the virtual character in a virtual environment.

17. The system of claim 16, wherein generating the skeleton comprises:
applying a trained machine learning model to the 3D mesh to obtain predicted joint locations of the plurality of joints of the skeleton, wherein vertex positions, topological edges, and geodesic edges of the 3D mesh are provided as input to the trained machine learning model; and
building a skeleton hierarchy for the virtual character based on the predicted joint locations.

18. The system of claim 16, wherein the skinning weights are determined by:
mapping the 3D mesh to a decimated 3D mesh, wherein two or more vertices of the 3D mesh correspond to a single vertex of the decimated 3D mesh;
applying a trained second machine learning model to the decimated 3D mesh to determine intermediate skinning weights for the decimated 3D mesh, wherein a respective volumetric geodesic distance between individual pairs of vertices and bones are provided as input to the trained second machine learning model; and
calculating the skinning weights for each vertex of the 3D mesh based on the intermediate skinning weights and the mapping.

19. The system of claim 16, wherein segmenting the skinned 3D mesh into the plurality of body part meshes comprises determining vertices of the skinned 3D mesh associated with each body part based on the skinning weights.

20. The system of claim 16, wherein determining the cage mesh comprises:
applying a trained third machine learning model to the 3D mesh to determine a point cloud that includes a plurality of cage vertices and a canonical connectivity between the plurality of cage vertices;
forming a plurality of predicted cage mesh parts based on the plurality of vertices and a respective canonical connectivity for each vertex; and
determining the cage mesh by deforming vertices in the predicted cage mesh parts that lie inside a surface of the body mesh.
